(19) United States
(12) Patent Application Publication
(10) Pub. No.: US 2026/0168792 A1
(43) Pub. Date: Jun. 18, 2026

(54) ESTIMATION METHOD FOR BURIED PIPELINE DEPTH

(71) Applicant: Industrial Technology Research Institute, Hsinchu (TW)

(72) Inventors: Chih-Wei YEN, Hsinchu City (TW); Yu-Chi CHANG, Kaohsiung City (TW); Chun-Yuan LIN, Tainan City (TW); Hung-Ming CHEN, Tainan City (TW); Yi-Chen LI, Zhubei City (TW)

(73) Assignee: Industrial Technology Research Institute, Hsinchu (TW)

(21) Appl. No.: 19/094,365

(22) Filed: Mar. 28, 2025

(30) Foreign Application Priority Data
Dec. 16, 2024 (TW) 113148990

(51) Int. Cl. G01B 21/18; G06N 20/20

(52) U.S. Cl. CPC G01B 21/18; G06N 20/20

(57) ABSTRACT

An estimation method for buried pipeline depth is provided, which includes the following steps. Current seawater temperature measurement data is obtained. Current seabed temperature simulation data is generated according to the current seawater temperature measurement data using an ambient temperature estimation model. Current cable temperature simulation data is generated according to the current seabed temperature simulation data using a thermal fluid-solid coupling model. Current cable temperature measurement data is obtained. A current buried pipeline depth estimation result is generated according to the current cable temperature simulation data and the current cable temperature measurement data using a buried pipeline depth estimation model.

### CROSS REFERENCE TO RELATED APPLICATIONS

This Application claims priority of Taiwan Patent Application No. 113148990, filed on Dec. 16, 2024, the entirety of which is incorporated by reference herein.

### BACKGROUND OF THE INVENTION

### Field of the Invention

The present disclosure relates to an estimation method for the buried pipeline depth of the submarine cable.

### Description of the Related Art

In order to provide communication and power transmission between countries or regions, cables capable of transmitting large amounts of signals or power are usually laid between the two areas in question. For example, submarine cables can be laid in the ocean and buried in the seabed. Furthermore, in order to prevent submarine cables from being exposed due to scouring, or being damaged by fishing, anchoring of ships, or suspended vibrations, the buried pipeline depth of the submarine cables can be set to 1 meter below the trough of terrain changes.

However, sand wave activity in some areas is intense. For example, annual sand wave changes may be as high as tens of centimeters to several meters. In addition, long waves and storm surges may also cause tens of centimeters of erosion within just a 24-hour period due to the impact of typhoons. These factors can lead to damage to the submarine cables and pipelines buried at an insufficient depth. Moreover, insufficient buried pipeline depth often cannot be discovered immediately. When submarine cables are not buried deep enough and are not discovered immediately, unexpected damage may occur. Therefore, although existing submarine cables have largely met their intended purposes, they do not meet requirements in all respects. There are still some issues to overcome regarding submarine cables.

### BRIEF SUMMARY OF THE INVENTION

In some embodiments, an estimation method for buried pipeline depth is provided. The estimation method includes the following steps. Current seawater temperature measurement data is obtained. Current seabed temperature simulation data is generated according to the current seawater temperature measurement data using an ambient temperature estimation model. Current cable temperature simulation data is generated according to the current seabed temperature simulation data using a thermal fluid-solid coupling model. Current cable temperature measurement data is obtained. A current buried pipeline depth estimation result is generated according to the current cable temperature simulation data and the current cable temperature measurement data using a buried pipeline depth estimation model.

The estimation method for the buried pipeline depth of the present disclosure can be applied to real-time monitoring of the buried pipe depth of the submarine cable. In order to make the features and advantages of the present disclosure more comprehensible, various embodiments are specially cited below, together with the accompanying drawings, are described in detail below.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram showing the estimating system for the buried pipeline depth according to some embodiments of the present disclosure.

FIG. 2 is a schematic diagram showing the establishing method for the ambient temperature estimation model according to some embodiments of the present disclosure.

FIG. 3 is a schematic diagram showing the submarine cable according to some embodiments of the present disclosure.

FIG. 4A is a schematic diagram showing the application method for the thermal fluid-solid coupling model according to some embodiments of the present disclosure.

FIG. 4B is a flow chart showing the verification method for the thermal fluid-solid coupling model according to some embodiments of the present disclosure.

FIG. 5 is a schematic diagram showing the establishing method for the buried pipeline depth estimation model according to some embodiments of the present disclosure.

FIG. 6 is a schematic diagram showing the estimation method for buried pipeline depth according to some embodiments of the present disclosure.

FIG. 7 is a comparison chart showing the comparison between monitored temperature and simulated temperature of the submarine cable according to some embodiments of the present disclosure.

### DETAILED DESCRIPTION OF THE INVENTION

In order to make the above-mentioned objects, features, and benefits of some embodiments of the present disclosure more obvious and understandable, the following is a detailed description with reference to the accompanying drawings.

It should be understood that the terms “comprise”, “include” and the like used in this specification are used to indicate the presence of specific technical features, values, method steps, operation processes, elements, and/or components, but are not intended to exclude the possibility of adding more technical features, values, method steps, operation processing, elements, components, or any combination thereof.

The terms “first”, “second”, “third”, “fourth”, and the like used in the description and claims are used to modify elements and are not intended to imply and represent the element(s) have any previous ordinal numbers, and the use of these ordinal numbers is only used to clearly distinguished an element with a certain name and another element with the same name.

It should be understood that, in the following embodiments, features in several different embodiments may be replaced, recombined, and bonded to complete other embodiments without departing from the spirit of the present disclosure. The features of the various embodiments can be used in any combination as long as they do not violate the spirit of the present disclosure or conflict with each other.

Herein, the terms “about”, “substantially”, and the like generally mean within 10%, within 5%, within 3%, within 2%, within 1%, or within 0.5% of a given value or range. The given value is an approximate value, that is, “about”, “substantially”, and the like can still be implied without the specific description of “about” and “substantially”.

Unless otherwise defined, all terms (including technical and scientific terms) used herein have the same meaning as commonly understood by a person of ordinary skills in the art. It is understood that these terms, such as those defined in commonly used dictionaries, should be interpreted as having meanings consistent with the relevant art and the background or context of the present disclosure, and should not be interpreted in an idealized or overly formal manner, unless otherwise defined in the embodiments of the present disclosure.

Some variations of the embodiments are described below. In the different drawings and described embodiments, the same or similar reference numerals are used to designate the same or similar components. In some embodiments, additional steps may be provided before, during, and/or after a method, and some of the described processing steps may be replaced or deleted for other embodiments of the method.

In the existing technology, a survey vessel or underwater vehicle that is coupled with an acoustic sensor is usually used to measure the buried pipeline depth along the buried path of the submarine cable. However, this approach is time-consuming, making it impossible to monitor the depth of the submarine cable regularly or immediately. For example, the inspection frequency of the above-mentioned method may be once a year, and the error of the measured buried pipeline depth is as high as 10 cm to 15 cm. In addition, some methods for determining the buried pipeline depth of the submarine cable through data analysis can only obtain long-term data (or called steady-state data) of the buried pipeline depth but cannot obtain current data (or called transient-state data) of the buried pipeline depth. To this end, the present disclosure uses easily obtained seawater temperature and the internal temperature of the submarine cable and uses an estimation model obtained by machine learning to accurately and instantly determine the buried pipeline depth, thereby effectively solving some problems of the existing technology.

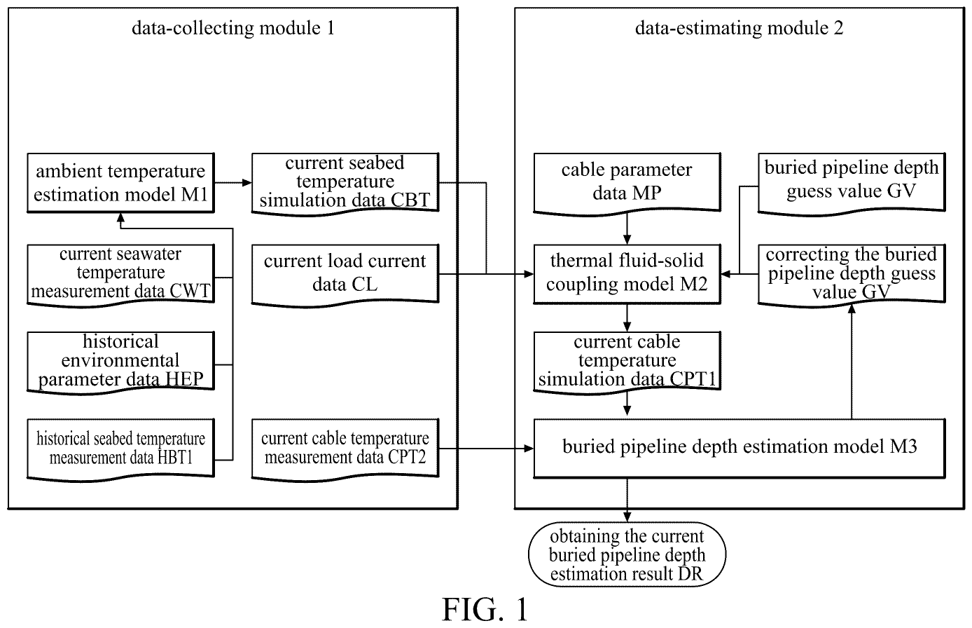

FIG. 1 is a schematic diagram showing the estimating system for buried pipeline depth according to some embodiments of the present disclosure. In some embodiments, the estimation method for the present disclosure may be implemented by the data-collecting module 1 and the data-estimating module 2 of the estimating system. Among them, the data-collecting module 1 is used to collect the data needed to estimate the buried pipeline depth, while the data-estimating module 2 estimates the buried pipeline depth according to the data collected by the data-collecting module 1. It should be noted that the estimating system in FIG. 1 is only used to make the present disclosure clearer and easier to understand and is not intended to limit the present disclosure. In other embodiments, estimating systems with different arrangements may also be used, and the buried pipeline depth may be estimated according to the steps hereinafter.

Specifically, the present disclosure uses the ambient temperature estimation model M1, the thermal fluid-solid coupling model M2, and the buried pipeline depth estimation model M3 to estimate the real-time buried pipeline depth (i.e., the current buried pipeline depth estimation result DR) according to the currently measured seawater temperature (i.e., the current seawater temperature measurement data CWT) and the cable temperature (i.e., the current cable temperature measurement data CPT2). Among them, the ambient temperature estimation model M1 may be used to estimate the seabed temperature at the buried pipeline location (i.e., the current seabed temperature simulation data CBT), the thermal fluid-solid coupling model M2 may be used to estimate the cable temperature (or pipeline cross-section temperature) (i.e., the current cable temperature simulation data CPT1), and the buried pipeline depth estimation model M3 may be used to estimate the buried pipeline depth (i.e., the current buried pipeline depth estimation result DR).

In some embodiments, the data-collecting module 1 and the data-estimating module 2 may include various electronic devices recognized by a person having ordinary skill in the art, such as a processor, a computer-readable media, and a memory processing and storage components, to execute computer programs to perform the functions described above. Among them, the examples of the processor may include a central processing unit (CPU), a multi-core CPU, a graphics processing unit (GPU), etc., but the present disclosure is not limited thereto. The examples of computer-readable media may include a compact disc read-only memory (CD-ROM), a hard drive, an erasable programable read-only memory (EPROM), an electrically erasable programmable read-only memory (EEPROM), etc., but the present disclosure is not limited thereto. The examples of memory may include a dynamic random access memory (DRAM), a static random access memory (SRAM), a flash memory, etc., but the present disclosure is not limited thereto.

It should be noted that the term “computer program” used herein refers to an application program stored in a computer-readable media that may be read into the memory for processing by the processor. In some embodiments, the application programs may be written in any combination of one or more programming languages. The programming languages include object-oriented programming languages, such as Java, Smalltalk, C++, python, or similar languages, as well as traditional programming languages, such as the C programming language or similar programming languages.

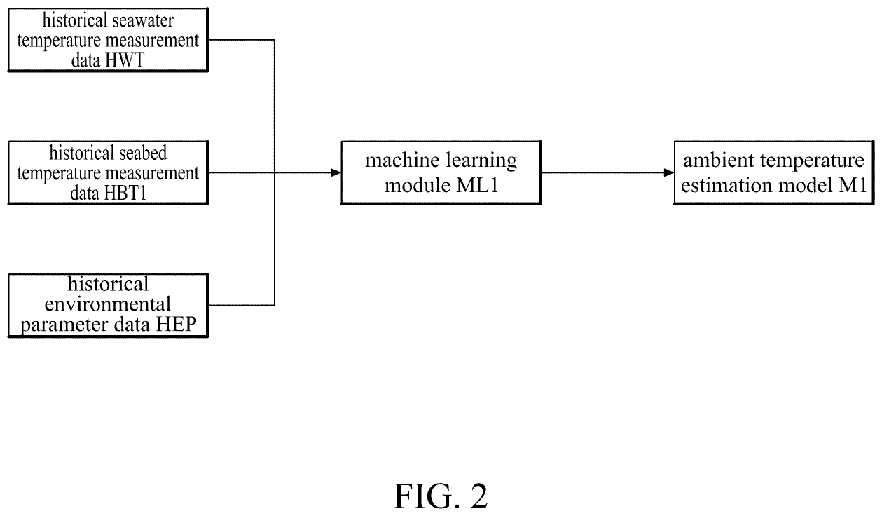

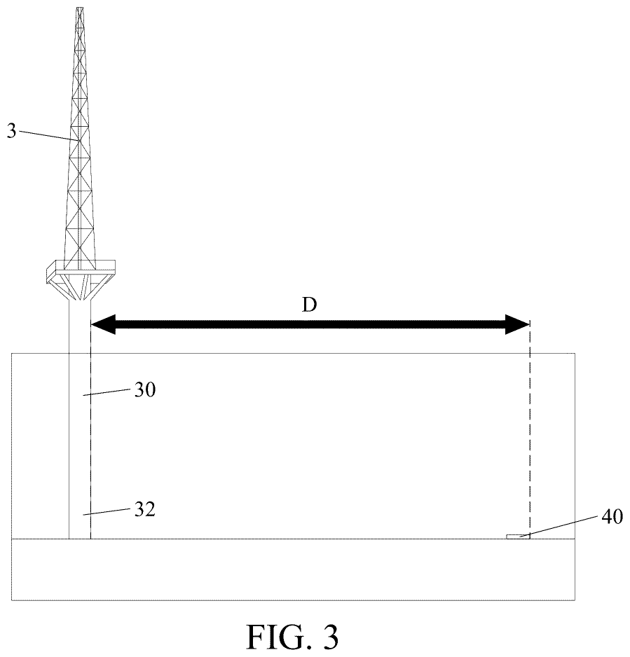

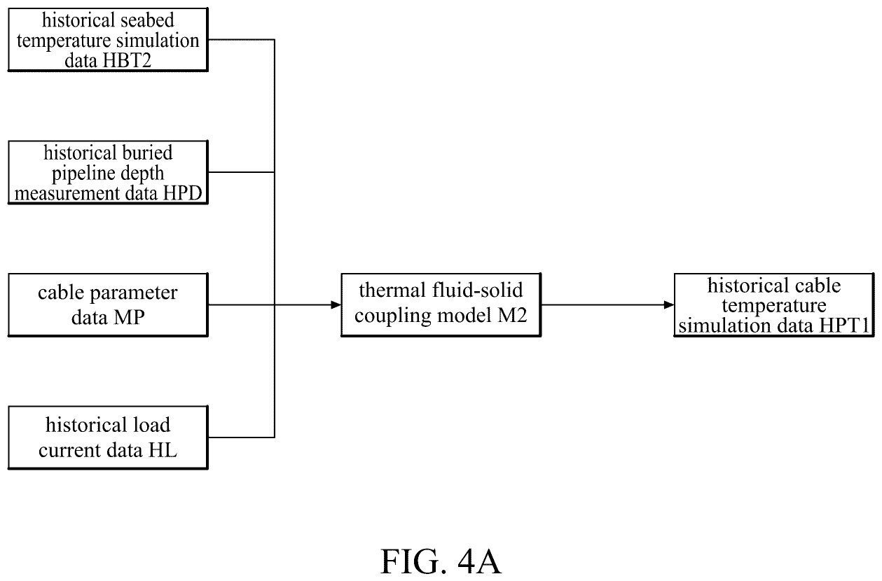

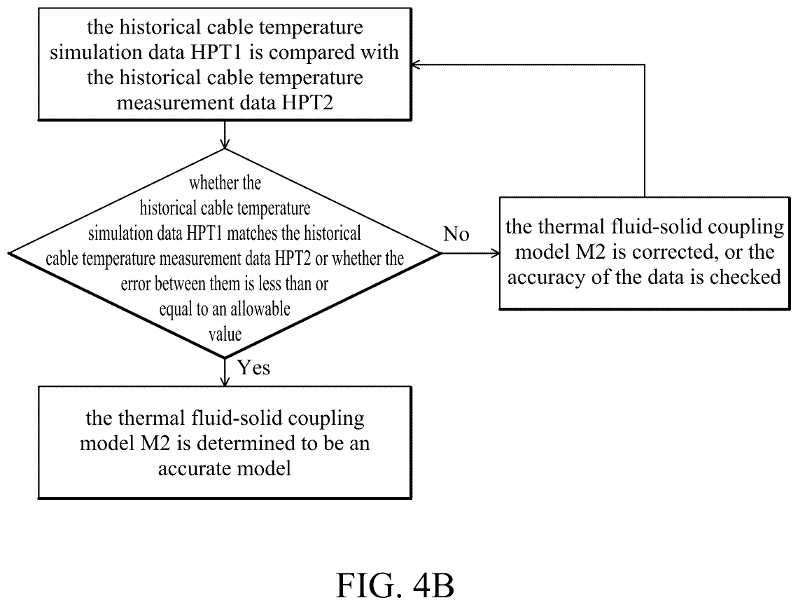

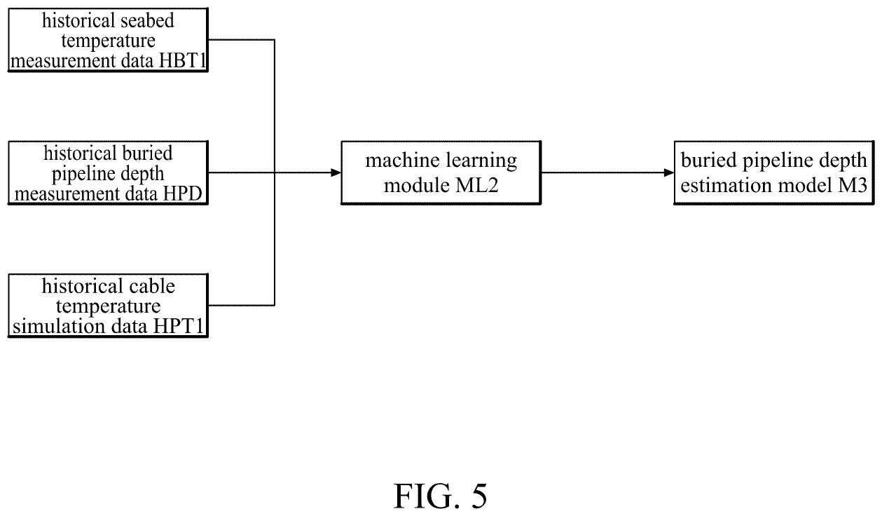

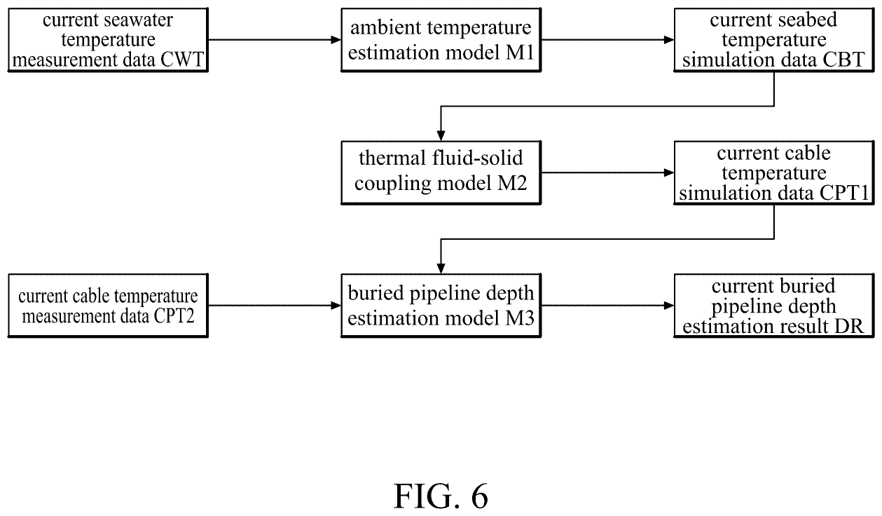

For further explanation, how each model is established and operates is described below. FIG. 2 is a schematic diagram showing the establishing method for the ambient temperature estimation model according to some embodiments of the present disclosure. FIG. 3 is a schematic diagram showing the submarine cable according to some embodiments of the present disclosure. FIG. 4A is a schematic diagram showing the application method for the thermal fluid-solid coupling model according to some embodiments of the present disclosure. FIG. 4B is a flow chart showing the verification method for the thermal fluid-solid coupling model according to some embodiments of the present disclosure. FIG. 5 is a schematic diagram showing the establishing method for the buried pipeline depth estimation model according to some embodiments of the present disclosure. FIG. 6 is a schematic diagram showing the estimation method for buried pipeline depth according to some embodiments of the present disclosure.

As shown in FIG. 2, the estimation method for buried pipeline depth may include establishing the ambient temperature estimation model M1. Among them, establishing the ambient temperature estimation model M1 includes the following steps.

First, a historical seawater temperature measurement data HWT is obtained. Specifically, as shown in FIG. 3, the historical seawater temperature measurement data HWT refers to the recorded seawater temperature at the measurement location 30 or the measurement location 32. Among them, the measurement location 30 corresponds to the upper layer of the ocean (e.g., Epipelagic Zone), and the measurement location 32 corresponds to the lower layer of the ocean (e.g., Mesopelagic Zone, Bathypelagic Zone, or Abyssopelagic Zone). In some embodiments, a first measuring device 3 may be used to measure the seawater temperature at the measurement location 30 in the upper layer of the ocean or the seawater temperature at the measurement location 32 in the lower layer of the ocean. For example, the first measuring device 3 may include a walrus observation facility such as a sea observation tower, but the present disclosure is not limited thereto. In some embodiments, the historical seawater temperature measurement data HWT may include seawater temperature data within months, years, or decades, but the present disclosure is not limited thereto. For example, the number of months may be three months, thirty months, fifty months, or one hundred months, but the present disclosure is not limited thereto. In some embodiments, the time interval between two adjacent pieces of seawater temperature data may be hours, days, weeks, months, or years, but the present disclosure is not limited thereto. For example, the number of hours may be three hours, thirty hours, fifty hours, or one hundred hours, but the present disclosure is not limited thereto.

As shown in FIG. 2, following the steps outlined above, a historical seabed temperature measurement data HBT1 is obtained. Specifically, as shown in FIG. 3, the historical seabed temperature measurement data HBT1 refers to the recorded seabed temperature at the buried pipeline location 40 of the submarine cable. In some embodiments, a second measuring device (not shown) may be used to measure the seabed temperature at the buried pipeline location 40 of the submarine cable. For example, the second measuring device may include pipeline monitoring equipment such as underwater vehicles, but the present disclosure is not limited thereto. In some embodiments, the historical seabed temperature measurement data HBT1 may include seabed temperature data within months, years, or decades, but the present disclosure is not limited thereto. In some embodiments, the time interval between two adjacent pieces of seabed temperature data may be hours, days, weeks, months, or years, but the present disclosure is not limited thereto.

As shown in FIG. 3, in some embodiments, the distance D between the seawater temperature measurement location 30 (or measurement location 32) and the buried pipeline location 40 may be greater than 1 km. For example, the distance D between the walrus observation facility and the buried pipeline location 40 may be 1 km, 3 km, 5 km, 6 km, 7 km, 8 km, or more than 8 km. In other words, the present disclosure may be applied to a submarine cable at a specific distance from a walrus observation facility, thereby significantly reducing the manpower and material costs required for actual exploration.

As shown in FIG. 2, following the steps outlined above, a historical environmental parameter data HEP is obtained. Specifically, the historical environmental parameter data HEP refers to event data that may affect seawater temperature. For example, the historical environmental parameter data HEP may include daily net radiation data, rainfall data, typhoon data, earthquake data, ship oil spill data, other event data recognized by a person having ordinary skill in the art, or a combination thereof, but the present disclosure is not limited thereto. In other words, the historical environmental parameter data HEP may be used to further improve or correct the degree of correlation between the historical seawater temperature measurement data HWT and the historical seabed temperature measurement data HBT1. In some embodiments, since the upper layer of the ocean is more susceptible to the influence of sunlight or weather, the historical environmental parameter data HEP may be more relevant to the seawater temperature of the upper layer of the ocean. In other words, when the seawater temperature in the lower layer of the ocean is used, obtaining the historical environmental parameter data HEP may be omitted.

Following the steps outlined above, a machine learning module ML1 is used to establish the ambient temperature estimation model M1 according to the historical seawater temperature measurement data HWT and the historical seabed temperature measurement data HBT1 and optionally according to the historical environmental parameter data HEP. In some embodiments, the machine learning module ML1 may adopt a supervised learning method, such as eXtreme Gradient Boosting, Random Forest, Decision tree, Support vector, or other suitable supervised learning methods, for learning and training by taking the historical seawater temperature measurement data HWT and historical environmental parameter data HEP as input conditions and by taking historical seabed temperature measurement data HBT1 as an output condition. In this way, the ambient temperature estimation model M1 generated through learning and training may effectively estimate the seabed temperature at the buried pipeline location.

In some embodiments, the machine learning module ML1 may also include a plurality of machine learning sub-modules, and the machine learning sub-modules may adopt different supervised learning methods. Specifically, the machine learning sub-modules are trained to establish a plurality of ambient temperature estimating sub-models by taking the historical seawater temperature measurement data HWT and the historical environmental parameter data HEP as input conditions and by taking the historical seabed temperature measurement data HBT1 may be taken as the output condition. Then, the one with the smallest error among the ambient temperature estimating sub-models is selected as the ambient temperature estimation model M1. In other words, this approach may further improve the estimation accuracy of the ambient temperature estimation model M1.

As described above, the ambient temperature estimation model M1 for estimating the seabed temperature at the buried pipeline location may be obtained. As shown in FIG. 1, in subsequent applications, the current seawater temperature measurement data CWT may be input into the ambient temperature estimation model M1 to estimate the current seabed temperature simulation data CBT.

As shown in FIG. 4A, the estimation method for buried pipeline depth may include obtaining cable temperature simulation data (e.g., historical cable temperature simulation data or current cable temperature simulation data) using the thermal fluid-solid coupling model M2. Among them, obtaining the cable temperature simulation data using the thermal fluid-solid coupling model M2 includes the following steps.

First, a historical seabed temperature simulation data HBT2 is obtained. Specifically, the historical seabed temperature simulation data HBT2 refers to the recorded seabed temperature at the buried pipeline location estimated by the ambient temperature estimation model M1. For example, the historical seabed temperature simulation data HBT2 may be estimated by inputting the historical seawater temperature measurement data HWT into the ambient temperature estimation model M1. In some embodiments, the historical seabed temperature simulation data HBT2 may include seabed temperatures at buried pipeline locations within months, years, or decades, but the present disclosure is not limited thereto. In some embodiments, the time interval between two adjacent pieces of the seabed temperature at the buried pipeline location may be hours, days, weeks, months, or years, but the present disclosure is not limited thereto. It should be noted that although the seabed temperature used here to verify the thermal fluid-solid coupling model M2 is estimated data, the present disclosure is not limited thereto. In some embodiments, the historical seabed temperature measurement data HBT1 that is actually measured may also be used to verify the thermal fluid-solid coupling model M2.

Following the steps outlined above, a historical buried pipeline depth measurement data HPD is obtained. Specifically, the historical buried pipeline depth measurement data HPD refers to the recorded buried pipeline depth of the submarine cable. In some embodiments, a third measuring device (not shown) may be used to measure the depth of the submarine cable. For example, the third measuring device may include pipeline monitoring equipment such as underwater vehicles, but the present disclosure is not limited thereto. In some embodiments, the historical buried pipeline depth measurement data HPD may include buried pipeline depth data of the submarine cable within months, years, or decades, but the present disclosure is not limited thereto. In some embodiments, the time interval between two adjacent pieces of buried pipeline depth data may be hours, days, weeks, months, or years, but the present disclosure is not limited thereto.

Following the steps outlined above, a cable parameter data MP is obtained. Specifically, the cable parameter data MP refers to various parameters related to submarine cables. For example, the parameters include pipeline material, pipeline length, heat loss rate, thermal conductivity, heat transfer coefficient, specific heat, density, other parameters, or a combination thereof that are recognized by a person having ordinary skill in the art, but the present disclosure is not limited thereto. In other words, the cable parameter data MP may be used to estimate the heat energy that the submarine cable may generate during operation and the possible temperature during operation.

Following the steps outlined above, a historical load current data HL is obtained. Specifically, the historical load current data HL refers to the recorded load current value through the submarine cable. In some embodiments, a fourth measuring device (not shown) may be used to measure the load current value through the submarine cable. For example, the fourth measuring device may include a pipeline monitoring device such as a current sensor, but the present disclosure is not limited thereto. In some embodiments, the historical load current data HL may include load current data within months, years, or decades, but the present disclosure is not limited thereto. In some embodiments, the time interval between two adjacent pieces of load current data may be hours, days, weeks, months or years, but the present disclosure is not limited thereto.

Following the steps outlined above, a historical cable temperature simulation data HPT1 is generated according to the historical seabed temperature simulation data HBT2, the historical buried pipeline depth measurement data HPD, the cable parameter data MP, and the historical load current data HL using the thermal fluid-solid coupling model M2. Similarly, in some embodiments, the historical seabed temperature simulation data HBT2 may also be replaced with the current seabed temperature simulation data CBT to obtain a current cable temperature simulation data CPT1. The historical cable temperature simulation data HPT1 or the current cable temperature simulation data CPT1 herein may be used for the subsequent estimation method.

As shown in FIG. 4B, in some embodiments, the estimation method for the buried pipeline depth may also include verifying the accuracy of the thermal fluid-solid coupling model M2. Among them, verifying the thermal fluid-solid coupling model M2 includes the following steps.

First, a historical cable temperature measurement data HPT2 is obtained. Specifically, the historical cable temperature measurement data HPT2 refers to the recorded cable temperature of the submarine cable. In some embodiments, the cable temperature of the submarine cable may be measured by a fifth measuring device (not shown). For example, the fifth measurement device may include a pipeline monitoring device such as an optical fiber, but the present disclosure is not limited thereto. In some embodiments, the historical cable temperature measurement data HPT2 may include cable temperature data within months, years, or decades, but the present disclosure is not limited thereto. In some embodiments, the time interval between two adjacent pieces of cable temperature data may be hours, days, weeks, months, or years, but the present disclosure is not limited thereto.

Following the steps outlined above, the historical cable temperature simulation data HPT1 is compared with the historical cable temperature measurement data HPT2 to verify the accuracy of the thermal fluid-solid coupling model M2. When the historical cable temperature simulation data HPT1 matches the historical cable temperature measurement data HPT2 or the error between them is less than or equal to an allowable value, the thermal fluid-solid coupling model M2 is determined to be an accurate model. On the contrary, when the historical cable temperature simulation data HPT1 and the historical cable temperature measurement data HPT2 do not match or the error between them is greater than an allowable value, the thermal fluid-solid coupling model M2 is corrected, or the accuracy of the data is checked.

As mentioned above, the accuracy of the thermal fluid-solid coupling model M2 used to estimate the internal temperature (or cross-section temperature) of the pipeline has been confirmed. As shown in FIG. 1, in subsequent applications, the current seabed temperature simulation data CBT, the buried pipeline depth guess value GV (described hereinafter), the cable parameter data MP, and the current load current data CL may be input into the thermal fluid-solid coupling model M2 to estimate the current cable temperature simulation data CPT1.

As shown in FIG. 5, the estimation method for buried pipeline depth may include establishing the buried pipeline depth estimation model M3. Among them, establishing the buried pipeline depth estimation model M3 includes the following steps.

First, a historical seabed temperature measurement data HBT1 is obtained. Specifically, the historical seabed temperature measurement data HBT1 refers to the recorded seabed temperature at the buried pipeline location of the submarine cable. Among them, the historical seabed temperature measurement data HBT1 used herein to establish the buried pipeline depth estimation model M3 may be similar or identical to the historical seabed temperature measurement data HBT1 used to establish the ambient temperature estimation model M1 above. Therefore, the detailed description may be referred to above and is omitted here.

Following the steps outlined above, a historical buried pipeline depth measurement data HPD is obtained. Specifically, the historical buried pipeline depth measurement data HPD refers to the recorded buried pipeline depth of the submarine cable. Among them, the historical buried pipeline depth measurement data HPD used herein to establish the buried pipeline depth estimation model M3 may be similar or identical to the historical buried pipeline depth measurement data HPD used to verify the thermal fluid-solid coupling model M2 above. Therefore, the detailed description may be referred to above and is omitted here.

Following the steps outlined above, a historical cable temperature simulation data HPT1 is obtained. Specifically, the historical cable temperature simulation data HPT1 refers to the cable temperature simulation data generated by the thermal fluid-solid coupling model M2. Therefore, the detailed description may be referred to above and is omitted here.

Following the steps outlined above, the buried pipeline depth estimation model M3 is established according to the historical seabed temperature measurement data HBT1, the historical buried pipeline depth measurement data HPD, and the historical cable temperature simulation data HPT1 using a machine learning module ML2. In some embodiments, the machine learning module ML2 may adopt a supervised learning method, such as eXtreme Gradient Boosting, Random Forest, Decision tree, Support vector, or other suitable supervised learning methods, for learning and training by taking the historical seabed temperature measurement data HBT1 and the historical cable temperature simulation data HPT1 as input conditions and by taking the historical buried pipeline depth measurement data HPD as an output condition. In this way, the buried pipeline depth estimation model M3 generated through learning and training may effectively estimate the buried pipeline depth at the buried pipeline location.

Similar to the step of establishing the ambient temperature estimation model M1, in some embodiments, the machine learning module ML2 may also include a plurality of machine learning sub-modules, and the machine learning sub-modules may adopt different supervised learning methods. Specifically, the machine learning sub-modules may be trained to establish a plurality of buried pipeline depth estimating sub-models by taking the historical seabed temperature measurement data HBT1 and the historical cable temperature simulation data HPT1 as input conditions and by taking the historical buried pipeline depth measurement data HPD as an output condition. Then, the one with the smallest error among the buried pipeline depth estimating sub-models is selected as the buried pipeline depth estimation model M3. In other words, this approach may further improve the estimation accuracy of the buried pipeline depth estimation model M3.

As described above, the buried pipeline depth estimation model M3 for estimating the buried pipeline depth at the buried pipeline location may be obtained. As shown in FIG. 1, in subsequent applications, the current seawater temperature measurement data CWT measured by the measuring device (e.g., the first measuring device 3) may be input into the ambient temperature estimation model M1 to obtain the current seabed temperature simulation data CBT. Then, the current seabed temperature simulation data CBT may be input into the thermal fluid-solid coupling model M2 to obtain the current cable temperature simulation data CPT1. Finally, the current cable temperature simulation data CPT1 is input into the buried pipeline depth estimation model M3 to estimate the current buried pipeline depth estimation result DR.

In the above, the establishment and operation methods of the ambient temperature estimation model M1, the thermal fluid-solid coupling model M2, and the buried pipeline depth estimation model M3 have been roughly described. Next, in the following, how to estimate the buried pipeline depth by using the above models will be described according to some embodiments of the present disclosure.

As shown in FIG. 6, the estimation method for buried pipeline depth includes the following steps. The current seawater temperature measurement data CWT is obtained. For example, the current seawater temperature in the upper layer of the ocean (e.g., Epipelagic Zone) or the seawater temperature in the lower layer of the ocean (e.g., Mesopelagic Zone, Bathypelagic Zone, or Abyssopelagic Zone) may be obtained by a walrus observation facility such as a sea observation tower. It should be noted that the term “current” herein refers to data measured or estimated within a time range, such as data obtained within 24 hours, but the present disclosure is not limited thereto.

Following the steps outlined above, the current seabed temperature simulation data CBT is generated according to the current seawater temperature measurement data CWT using the ambient temperature estimation model M1. As mentioned above, the ambient temperature estimation model M1 has taken into account the correlation between seawater temperature and seabed temperature and has also taken into account events that may affect seawater temperature. Therefore, the error value of the current seabed temperature simulation data CBT may be less than 0.1° C., so it may be used as a valid numerical value.

Following the steps outlined above, the current cable temperature simulation data CPT1 is generated according to the current seabed temperature simulation data CBT using the thermal fluid-solid coupling model M2. As shown in FIG. 1, specifically, this step includes: obtaining the current seabed temperature simulation data CBT; generating the buried pipeline depth guess value GV; obtaining the cable parameter data MP; obtaining the current load current data CL; and generating the current cable temperature simulation data CPT1 according to the current seabed temperature simulation data CBT, the buried pipeline depth guess value GV, the cable parameter data MP, and the current load current data CL using the thermal fluid-solid coupling model M2. The buried pipeline depth guess value GV may be a hypothetical value provided according to historical data, and this hypothetical value is used as the possible buried pipeline depth. In addition, the load current value passing through the submarine cable (i.e., the current load current data CL) may be measured by a pipeline monitoring device such as a current sensor. In other words, this step estimates the possible cable temperature (i.e., the current cable temperature simulation data CPT1) by assuming the possible buried pipeline depth.

As shown in FIG. 6, following the steps outlined above, a current cable temperature measurement data CPT2 is obtained. For example, the current cable temperature of the submarine cable may be obtained through a pipeline monitoring device such as an optical fiber.

As shown in FIGS. 1 and 6, following the steps outlined above, the current buried pipeline depth estimation result DR is generated according to the current cable temperature simulation data CPT1 and the current cable temperature measurement data CPT2 using the buried pipeline depth estimation model M3. Specifically, this step includes: comparing the current cable temperature simulation data CPT1 with the current cable temperature measurement data CPT2. When the difference between the current cable temperature simulation data CPT1 and the current cable temperature measurement data CPT2 is less than or equal to an allowable value, it is determined that the buried pipeline depth guess value GV is the current buried pipeline depth estimation result DR. For example, if the root mean square error between the current cable temperature simulation data CPT1 and the current cable temperature measurement data CPT2 is less than or equal to 0.20° C., the buried pipeline depth guess value GV is determined to be the current buried pipeline depth estimation result DR. In other words, when the cable temperature derived from the above model is consistent with the actual measured cable temperature, the assumed buried pipeline depth may be considered to be the real buried pipeline depth. It should be noted that the above allowable values are only examples, and the present disclosure is not limited thereto. A person having ordinary skill in the art may adjust the allowable value according to the actual situation.

On the other hand, when the difference between the current cable temperature simulation data CPT1 and the current cable temperature measurement data CPT2 is greater than the allowable value, it is determined that the buried pipeline depth guess value GV is not the current buried pipeline depth estimation result DR. In addition, the step of generating the current buried pipeline depth estimation result DR using the buried pipeline depth estimation model M3 further includes correcting the buried pipeline depth guess value GV, and repeating the steps outlined above until the cable temperature inferred by the above model is matched with the actual measured cable temperature.

In some embodiments, the execution interval of the step of generating the current buried pipeline depth estimation result DR according to the current cable temperature simulation data CPT1 and the current cable temperature measurement data CPT2 using the buried pipeline depth estimation model M3 is between 1 hour and 10 hours. It should be noted that the above execution interval is only an example, and the present disclosure is not limited thereto. A person having ordinary skill in the art may adjust the execution interval according to actual conditions. In other words, compared with the steady-state analysis in the prior art, which is performed at intervals of several months, the present disclosure realizes transient analysis with an interval of several hours, so that the submarine cable can be monitored in real time and relevant personnel can be promptly reported when a problem occurs.

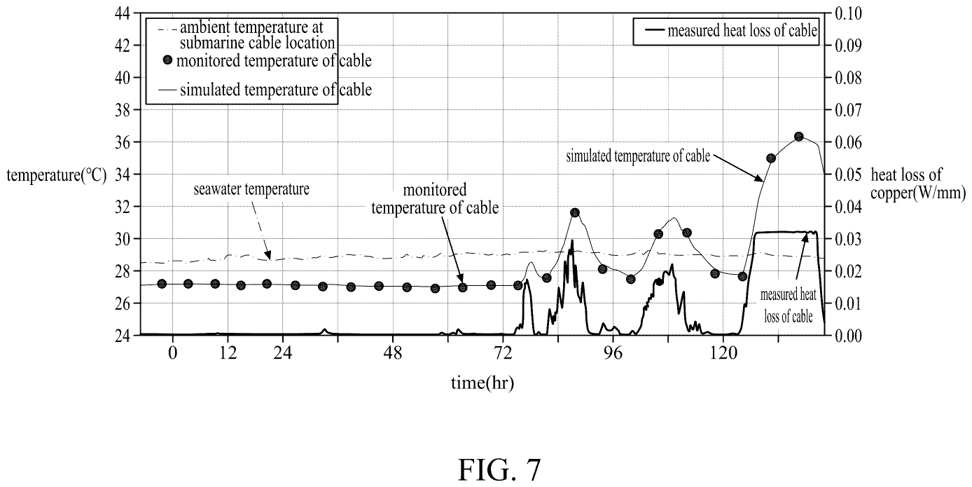

FIG. 7 is a comparison chart showing the monitored temperature and the simulated temperature of the submarine cable according to some embodiments of the present disclosure. As shown in the figure, the estimation method of the present disclosure may have excellent accuracy after using machine learning. It may be known from the comparison chart that the monitored temperature of the submarine cable (i.e., the current cable temperature measurement data CPT2) and the simulated temperature of the submarine cable (i.e., the current cable temperature simulation data CPT1) are consistent with each other. In this case, it may be determined that the buried pipeline depth guess value GV assumed in the model may be regarded as the current buried pipeline depth estimation result DR and is similar or identical to the actual value. In some embodiments, the error value of the current buried pipeline depth estimation result DR is less than 10 cm. For example, the difference between the current buried pipeline depth estimation result DR and the actual buried pipeline depth may be 5 cm, 3 cm, 1 cm, or less than 1 cm. In other words, the current buried pipeline depth estimation result DR of the present disclosure is accurate enough and may be regarded as the actual buried pipeline depth. It should be noted that the above error values are only examples, and the present disclosure is not limited thereto. A person having ordinary skill in the art can understand that the upper limit of the error value may be redefined according to actual usage conditions.

In summary, the embodiments of the present disclosure provide an estimation method for the buried pipeline depth of the submarine cable. Specifically, the present disclosure uses easily obtained seawater temperature and the internal temperature of the submarine cable, and uses an estimation model obtained by machine learning to accurately and instantly determine the buried pipeline depth, thereby effectively solving some of the problems of the existing technology.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A estimation method for buried pipeline depth, comprising:
obtaining a current seawater temperature measurement data;
generating a current seabed temperature simulation data according to the current seawater temperature measurement data using an ambient temperature estimation model;
generating a current cable temperature simulation data according to the current seabed temperature simulation data using a thermal fluid-solid coupling model;
obtaining a current cable temperature measurement data; and
generating a current buried pipeline depth estimation result according to the current cable temperature simulation data and the current cable temperature measurement data using a buried pipeline depth estimation model.

2. The estimation method for buried pipeline depth as claimed in claim 1, further comprising:
establishing the buried pipeline depth estimation model, wherein the step of establishing the buried pipeline depth estimation model comprises:
obtaining a historical seabed temperature measurement data;
obtaining a historical buried pipeline depth measurement data;
obtaining a historical cable temperature simulation data; and
establishing the buried pipeline depth estimation model according to the historical seabed temperature measurement data, the historical buried pipeline depth measurement data, and the historical cable temperature simulation data using a machine learning module.

3. The estimation method for buried pipeline depth as claimed in claim 2, wherein the machine learning module comprises a plurality of machine learning sub-modules, wherein
the step of establishing the buried pipeline depth estimation model further comprises:
training the plurality of machine learning sub-modules to establish a plurality of buried pipeline depth estimating sub-models by taking the historical seabed temperature measurement data and the historical cable temperature simulation data as input conditions and by taking the historical buried pipeline depth measurement data as an output condition; and
selecting the one with the smallest error among the plurality of buried pipeline depth estimating sub-models as the buried pipeline depth estimation model.

4. The estimation method for buried pipeline depth as claimed in claim 3, wherein the learning methods of the plurality of machine learning sub-modules comprise eXtreme Gradient Boosting, Random Forest, Decision Tree, or Support vector.

5. The estimation method for buried pipeline depth as claimed in claim 3, wherein
the step of generating the current buried pipeline depth estimation result using the buried pipeline depth estimation model comprises:
generating a buried pipeline depth guess value;
generating the current cable temperature simulation data according to the current seabed temperature simulation data and the buried pipeline depth guess value using the thermal fluid-solid coupling model; and
comparing the current cable temperature simulation data with the current cable temperature measurement data,
wherein the buried pipeline depth guess value is determined to be the current buried pipeline depth estimation result when the difference between the current cable temperature simulation data and the current cable temperature measurement data is less than or equal to an allowable value.

6. The estimation method for buried pipeline depth as described in claim 5, wherein the buried pipeline depth guess value is not determined to be the current buried pipeline depth estimation result when the difference between the current cable temperature simulation data and the current cable temperature measurement data is greater than the allowable value, and
the step of generating the current buried pipeline depth estimation result using the buried pipeline depth estimation model further comprises:
correcting the buried pipeline depth guess value.

7. The estimation method for buried pipeline depth as claimed in claim 1, wherein
the step of generating the current cable temperature simulation data using the thermal fluid-solid coupling model comprises:
obtaining the current seabed temperature simulation data;
generating a buried pipeline depth guess value; and
generating the current cable temperature simulation data according to the current seabed temperature simulation data and the buried pipeline depth guess value using the thermal fluid-solid coupling model.

8. The estimation method for buried pipeline depth as claimed in claim 7, wherein
the step of generating the current cable temperature simulation data using the thermal fluid-solid coupling model further comprises:
obtaining a cable parameter data;
obtaining a current load current data; and
generating the current cable temperature simulation data according to the current seabed temperature simulation data, the buried pipeline depth guess value, the cable parameter data, and the current load current data using the thermal fluid-solid coupling model.

9. The estimation method for buried pipeline depth as claimed in claim 8, wherein the cable parameter data comprises pipeline material, pipeline length, heat loss rate, thermal conductivity, heat transfer coefficient, specific heat, density, or a combination thereof.

10. The estimation method for buried pipeline depth as claimed in claim 1, further comprising:
establishing the ambient temperature estimation model, wherein the step of establishing the ambient temperature estimation model comprises:
obtaining a historical seawater temperature measurement data;
obtaining a historical seabed temperature measurement data; and
establishing the ambient temperature estimation model according to the historical seawater temperature measurement data and the historical seabed temperature measurement data using a machine learning module.

11. The estimation method for buried pipeline depth as described in claim 10, wherein
the step of establishing the ambient temperature estimation model further comprises:
obtaining a historical environmental parameter data; and
establishing the ambient temperature estimation model according to the historical seawater temperature measurement data, the historical seabed temperature measurement data, and the historical environmental parameter data using the machine learning module.

12. The estimation method for buried pipeline depth as claimed in claim 11, wherein the historical environmental parameter data comprises daily net radiation data, rainfall data, or a combination thereof.

13. The estimation method for buried pipeline depth as claimed in claim 11, wherein the machine learning module comprises a plurality of machine learning sub-modules, wherein
the step of establishing the ambient temperature estimation model further comprises:
training the plurality of machine learning sub-modules to establish a plurality of ambient temperature estimating sub-models by taking the historical seawater temperature measurement data and the historical environmental parameter data as input conditions and by taking the historical seabed temperature measurement data as an output condition; and
selecting the one with the smallest error among the plurality of ambient temperature estimating sub-models as the ambient temperature estimation model.

14. The estimation method for buried pipeline depth as claimed in claim 13, wherein the learning methods of the plurality of machine learning sub-modules comprise eXtreme Gradient Boosting, Random Forest, Decision Tree, or Support vector.

15. The estimation method for buried pipeline depth as claimed in claim 1, wherein
the step of obtaining the current cable temperature measurement data comprises:
obtaining the current cable temperature measurement data through an optical fiber.

16. The estimation method for buried pipeline depth as claimed in claim 1, wherein the current seawater temperature measurement data comprises seawater temperature at the Epipelagic Zone, the Mesopelagic Zone, the Bathypelagic Zone, or the Abyssopelagic Zone.

17. The estimation method for buried pipeline depth as claimed in claim 1, further comprising verifying the accuracy of the thermal fluid-solid coupling model, wherein
the step of verifying the accuracy of the thermal fluid-solid coupling model comprises:
obtaining a historical cable temperature simulation data;
obtaining a historical cable temperature measurement data; and
comparing the historical cable temperature simulation data with the historical cable temperature measurement data to verify the accuracy of the thermal fluid-solid coupling model.

18. The estimation method for buried pipeline depth as claimed in claim 17, wherein
the step of obtaining a historical cable temperature simulation data comprises:
obtaining a historical seabed temperature simulation data;
obtaining a historical buried pipeline depth measurement data;
obtaining a cable parameter data;
obtaining a historical load current data; and
generating the historical cable temperature simulation data according to the historical seabed temperature simulation data, the historical buried pipeline depth measurement data, the cable parameter data, and the historical load current data using the thermal fluid-solid coupling model.

19. The estimation method for buried pipeline depth as claimed in claim 1, wherein an error value of the current buried pipeline depth estimation result is less than 10 cm.

20. The estimation method for buried pipeline depth as claimed in claim 1, wherein an execution interval of the step of generating the current buried pipeline depth estimation result is between 1 hour and 10 hours.
